(19) United States
(12) Patent Application Publication
(10) Pub. No.: US 2020/0119586 A1
(43) Pub. Date: Apr. 16, 2020

(54) WIRELESS CHARGING OF DEPLETED MOBILE DEVICE FOR ACCESS CONTROL

(71) Applicant: Avigilon Corporation, Vancouver (CA)

(72) Inventors: Pietro RUSSO, Melrose, MA (US); Bo Yang YU, Winchester, MA (US)

(73) Assignee: Avigilon Corporation, Vancouver (CA)

(21) Appl. No.: 16/160,472

(22) Filed: Oct. 15, 2018

(51) Int. Cl. H02J 50/10; H02J 7/02; H02J 7/00; G06F 21/44

(52) U.S. Cl. CPC H02J 50/10; G06F 21/445; H02J 7/0027; H02J 7/025

(57) ABSTRACT

For a mobile device with a depleted battery, an access control reader is configured to wirelessly transfer power, thereafter authorize an access request received from the mobile device, and, in response to authorizing the access request, grant access to a resource.

### FIELD OF THE DISCLOSURE

The present disclosure relates to methods and systems for wirelessly charging mobile devices that perform access control when sufficiently powered.

### BACKGROUND TO THE DISCLOSURE

Access control refers to the selective restriction of access to a physical location or to a resource such as data stored on a computer-readable medium. For instance, in the context of building security, a door for entering the building or for entering a floor of a building may be permanently locked to those who do not possess the required credentials. In order to pass through the locked door, a user must first validate their credentials with the system controlling access to (i.e. passage through) the door. Typically, this is done by bringing an access card (such as a key card) within close physical proximity of an access card reader positioned adjacent the door. Using near-field communication, an access token stored on the card is read by the reader. The reader validates the token and then unlocks the door for a limited period of time (i.e. temporarily), thereby permitting access therethrough.

A similar method may be performed in the context of an information resource, such as an encrypted data file. In order for a user to be granted access to the file, the user may first have to validate a token (e.g. the decryption key) stored on a key card. The reader in this case may be located adjacent a computer terminal with which the user is interfacing.

With the proliferation of mobile devices, it is becoming more common for a mobile device to act as the repository for a user's access tokens. For instance, rather than using a physical key card for accessing a portal, the user may instead bring their mobile device into proximity of the reader. The access token is then transmitted from the mobile device to the reader and, after validating the token, the reader grants access to the portal.

However, unlike physical key cards, a mobile device is powered by a rechargeable battery with a limited charge capacity. Therefore, it is quite possible that a user may find themselves unable to access a portal or some other resource in the event that their mobile device's battery is too far depleted.

### SUMMARY OF THE DISCLOSURE

In a first aspect of the disclosure, there is provided a method comprising: wirelessly transferring power from a power source to a mobile device, wherein the power source provides power to one or more components of an access control reader; receiving at the access control reader an access request from the mobile device, wherein the access request is for accessing a resource; authorizing, with access control reader, the access request; and in response to authorizing the access control request, granting, with access control reader, access to the resource.

The access request may comprise an access token. Authorizing the access request may comprise validating the access token.

Prior to wirelessly transferring power to the mobile device, a state of the charge of the mobile device may be insufficient to allow the mobile device to transmit the access request to the access control reader.

Prior to wirelessly transferring power to the mobile device, a state of charge of the mobile device may less insufficient to allow the mobile device to fully boot. A full boot of the mobile device may refer to the mobile device having initiated and completed a boot sequence, in particular a boot sequence that would be completed if the mobile device had a greater state of charge, such as 50% or 100%.

Wirelessly transferring power to the mobile device may comprise wirelessly transferring power using inductive coupling between the access control reader and the mobile device.

Receiving the access request may comprise receiving the access request over a Bluetooth® communication channel.

During the wireless transfer of power to the mobile device, the mobile device may be less than about 4 cm from the access control reader.

The resource may comprise a physical portal or a data file.

In a further aspect of the disclosure, there is provided a method comprising: wirelessly receiving power at a mobile device from an a power source, wherein the power source provides power to one or more components of an access control reader; transmitting an access request from the mobile device to the access control reader, wherein the access request is for accessing a resource; and in response to access to the resource being granted by the access control reader, accessing the resource.

Transmitting the access request may comprise using a secondary processor of the mobile device, wherein the secondary processor is configured to operate at one or more of a lower voltage and a lower frequency than a primary processor of the mobile device.

Transmitting the access request may comprise using a first portion of a processor of the mobile device, wherein the first portion is configured to operate at one or more of a lower voltage and a lower frequency than a second portion of the processor. The first and second portions of the processor may comprise respective power islands of the processor.

Transmitting the access request may comprise: activating an access control application on the mobile device; and using the access control application to transmit the access request. Prior to activating the access control application, the method may further comprise determining with the mobile device that the received power is less than a threshold power. The threshold power may be a power required for the mobile device to activate an operating system of the mobile device, or to fully boot the mobile device.

Activating the access control application may comprise using a secondary processor of the mobile device, wherein the secondary processor is configured to operate at one or more of a lower voltage and a lower frequency than a primary processor of the mobile device.

Activating the access control application may comprise using a first portion of a processor of the mobile device, wherein the first portion is configured to operate at one or more of a lower voltage and a lower frequency than a second portion of the processor. The first and second portions of the processor may comprise respective power islands of the processor.

The method may further comprise, prior to transmitting the access request: detecting a user input at the mobile device; and in response thereto, activating the access control application.

Prior to wirelessly receiving power at the mobile device, a state of the charge of the mobile device may be insufficient to allow the mobile device to transmit the access request.

Prior to wirelessly receiving power at the mobile device, a state of charge of the mobile device may insufficient to allow the mobile device to fully boot.

Wirelessly receiving power at the mobile device may comprise wirelessly receiving power using inductive coupling between the access control reader and the mobile device.

Transmitting the access request may comprise transmitting the access request over a Bluetooth® communication channel.

During the wireless receipt of power from the access control reader, the mobile device may be less than about 4 cm from the access control reader.

The method may further comprise, in response to detecting the wireless receipt of power at the mobile device, or in response to detecting a wireless transmission received at the mobile device from the access control reader, generating an override signal that initiates a boot sequence on the mobile device, wherein the override signal overrides a previous signal that prevented initiation of the boot sequence.

In a further aspect of the disclosure, there is provided an access control reader comprising: a wireless power transmitter; a power source for providing power to the wireless power transmitter; and one or more processors communicative with a memory having stored thereon computer program code configured when read by one or more processors to cause the one or more processors to perform a method. The method comprises: authorizing an access request received from a mobile device, wherein the access request is for accessing a resource; and granting access to the resource.

Authorizing the access request may comprise validating the access token. Validating the access token may comprise: comparing the access token to one or more pre-authorized access tokens; and determining that the access token corresponds to at least one of the one or more pre-authorized access tokens.

The wireless power transmitter may comprise an inductive coupler.

The access control reader may further comprise a Bluetooth® receiver for receiving the access request.

In a further aspect of the disclosure, there is provided a mobile device comprising: a transmitter; a processor having a first portion and a second portion, wherein the first portion is configured to operate at one or more of a lower voltage and a lower frequency than the second portion; and memory communicative with the first portion and having stored thereon computer program code configured when executed by the first portion to cause the first portion to perform a method. The method comprises transmitting with the transmitter an access request for accessing a resource.

Transmitting the access request may comprise transmitting an access token.

Transmitting the access request may comprise: activating an access control application; and using the access control application to transmit the access request.

The method may further comprise, prior to activating the access control application, determining that a wirelessly transferred power received at the mobile device is less than a threshold power. The threshold power may be a power required for the mobile device to activate an operating system of the mobile device, or to fully boot the mobile device.

The method may further comprise, prior to transmitting the access request: detecting a user input; and in response thereto, activating the access control application.

Prior to transmitting the access request, a state of the charge of the mobile device may be insufficient to allow the mobile device to transmit the access request.

Prior to transmitting the access request, a state of charge of the mobile device may insufficient to allow the mobile device to fully boot.

The mobile device may further comprise an inductive coupler.

The mobile device may further comprise a Bluetooth® transmitter.

The method may further comprise, in response to detecting wireless receipt of power at the mobile device, or in response to detecting a wireless transmission received at the mobile device from the access control reader, generating an override signal that initiates a boot sequence, wherein the override signal overrides a previous signal that prevented initiation of the boot sequence.

In a further aspect of the disclosure, there is provided a system comprising: a resource; a mobile device; and an access control reader; and a power source for providing power to the access control reader. The access control reader is configured to: wirelessly transfer power to the mobile device; thereafter, authorize an access request received from the mobile device; and in response to authorizing the access request, grant access to the resource.

In a further aspect of the disclosure, there is provided a computer-readable medium having stored thereon computer program code configured when executed by one or more processors to cause the one or more processors to perform any of the above-described methods.

This summary does not necessarily describe the entire scope of all aspects. Other aspects, features and advantages will be apparent to those of ordinary skill in the art upon review of the following description of example embodiments.

### BRIEF DESCRIPTION OF THE DRAWINGS

Example embodiments of the disclosure will now be described in conjunction with the accompanying drawings of which:

FIG. 1 is a diagram of a user using their mobile device to communicate with an access control reader to gain access to a portal;

FIG. 2 is a detailed block diagram of an access control reader and a mobile device, in accordance with embodiments of the disclosure; and

FIG. 3 is a flow diagram of a method of performing access control, in accordance with an embodiment of the disclosure.

### DETAILED DESCRIPTION OF EMBODIMENTS

Numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context.

As will be appreciated by one skilled in the art, the various example embodiments described herein may be embodied as a method, system, or computer program product. Accordingly, the various example embodiments may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the various example embodiments may take the form of a computer program product on a computer-usable storage medium having computer-usable program code embodied in the medium

Any suitable computer-usable or computer-readable medium may be used. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device.

Computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

Various example embodiments are described below with reference to flowchart illustration(s) and/or block diagram(s) of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

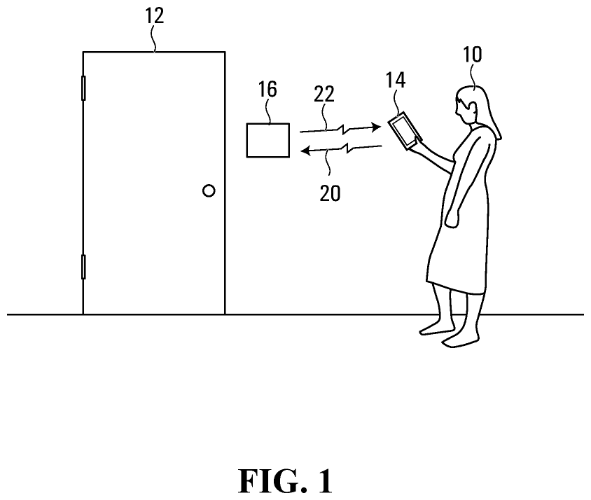

Referring now to FIG. 1, there is shown a user 10 seeking to gain access to a locked portal 12. User 10 is in possession of a mobile device 14 storing the necessary access token required to access portal 12. However, the battery of mobile device 14 is fully depleted, and therefore user 10 is unable to validate their access token in order to unlock portal 12. By bringing their mobile device 14 within close proximity of an access control reader 16, power is wirelessly transferred 20 from access control reader 16 to mobile device 14, through inductive coupling. Once sufficient power has been transferred from access control reader 16 to mobile device 14, mobile device 14 is able to transmit an access request to access control reader 16. In particular, mobile device 14 transmits 22 an access token to access control reader 16, whereupon the access token is detected by access control reader 16. Access control reader 16 validates the access token and, once the access token is validated, access control reader 16 unlocks door 12 for a limited period of time to allow user 10 access therethrough.

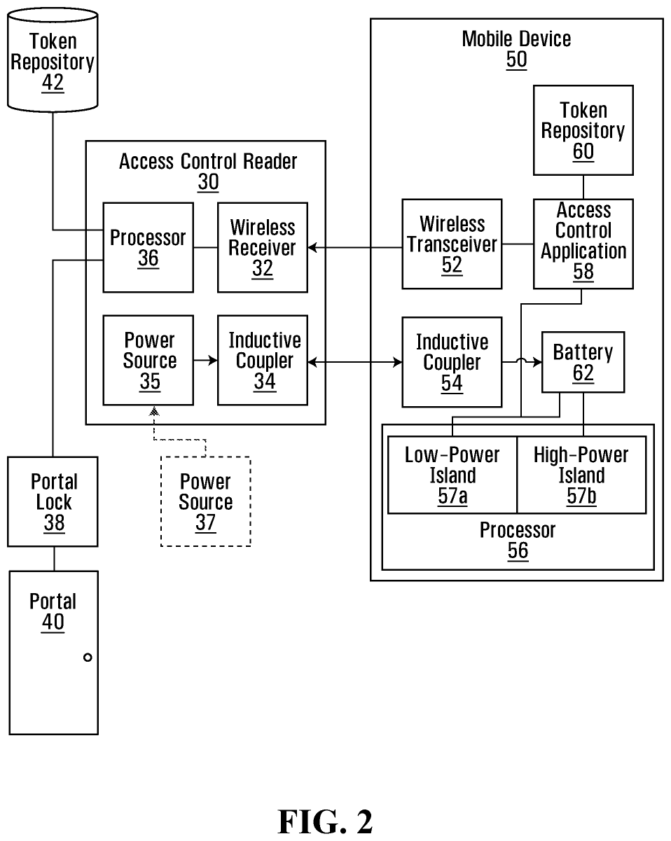

Turning now to FIG. 2, there is shown a detailed block diagram of an access control reader and a mobile device that may communicate with one another to implement, in accordance with a number of example embodiments, one or more of the methods described herein.

The access control reader 30 includes a wireless communications transceiver 32, an inductive coupler 34, an internal power source 35, and a processor 36. Wireless communications transceiver 32 may be for example a Bluetooth® transceiver configured to receive data over one or more Bluetooth®-standard communication channels. In some embodiments, wireless communications transceiver 32 is configured to receive data over one or more Bluetooth Low Energy (BLE) communication channels. However, the disclosure should be understood as encompassing all suitable wireless communication methods that may be used to allow access control reader 30 to communicate with the mobile device.

Inductive coupler 34 comprises for example a transmitting inductive coil configured to generate an alternating electromagnetic field using energy from internal power source 35. In some embodiments, internal power source 35 may itself be powered by an external power source 37. In some examples, external power source 37 may be a commonly available DC power supply (for instance, 12 Volts or 24 Volts). In other examples, external power source 37 may be some other type of known power source (for instance, a Power over Ethernet power source).

Processor 36 is configured to communicate with a portal lock 38 that restricts access to a portal 40, such as a door in a secured building. In particular, processor 36 is configured to control portal lock 38 so as to cause portal lock 38 to transition from a locked state to an unlocked state (in which access through portal 40 is possible). Communication between processor 36 and portal lock 38 may be over a network or not over a network (e.g. processor 36 may be directly connected to portal lock 38). Processor 36 is further configured to communicate with a remote token repository 42. For example, processor 36 may allow access control reader 30 to access and/or retrieve data from token repository 42 in order to validate an access token received at wireless communications transceiver 32. The connection between processor 36 and token repository 42 may be wired, wireless, or a combination of both. In other embodiments, token repository 42 may consist of local storage held directly on access control reader 30, in which case processor 36 may access token repository 42 directly on access control reader 30, without the need to access a remote repository.

The mobile device 50 includes a wireless communications transceiver 52, an inductive coupler 54, a processor 56, an access control application 58, a local token repository 60, and a battery 62. Wireless communications transceiver 52 may be for example a Bluetooth® transceiver configured to both transmit and receive data over one or more Bluetooth®-standard communication channels. In some embodiments, wireless communications transceiver 52 is configured to both transmit and receive data over one or more Bluetooth Low Energy (BLE) communication channels. However, the disclosure should be understood as encompassing all suitable wireless communication methods that may be used to allow mobile device 50 to communicate with access control reader 30.

Inductive coupler 54 comprises, for example, a receiving inductive coil configured to detect an alternating electromagnetic field and convert power from the electromagnetic field into electrical energy for storing in battery 62.

Processor 56 comprises multiple distinct portions or power islands. In the present embodiment, processor 56 includes a first, “low-power” island 57a and a second, “high-power” island 57b. Power islands, as known in the art, allow a processor to effectively operate in different power modes depending on the processor's current power requirements, enabling intelligent, adaptive power management. In particular, low-power island 57a is configured to operate at a lower voltage and/or clock frequency than high-power island 57b, and as such low-power island 57a is more suitable for low-power operations or operations that otherwise require less power than operations which would be better handled by high-power island 57b. Processor 56 may comprise, for example, an ARM big.LITTLE processor, developed by ARM Holdings.

Access control application 58 is used to initiate transmittal of an access request, using wireless communications transceiver 52. In particular, access control application 58 may retrieve an access token stored on token repository 60 and transmit the access token using wireless communications transceiver 52.

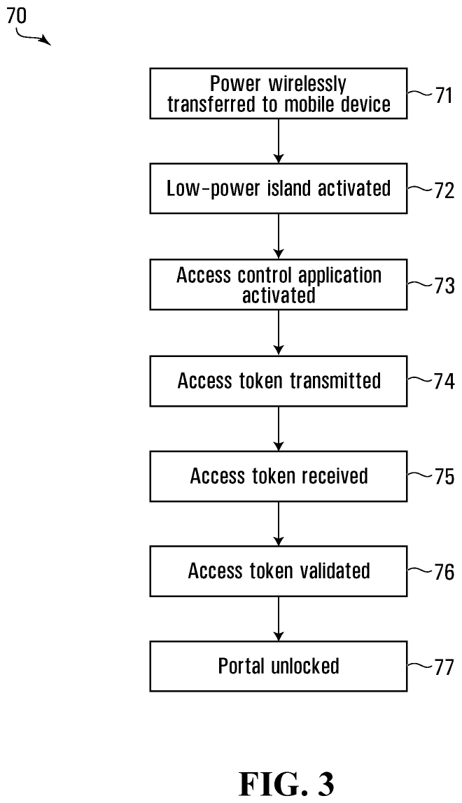

Turning now to FIG. 3, there is shown a flow diagram of a method 70 of performing access control, using access control reader 30 and mobile device 50 described above in connection with FIG. 2. At block 71, access control reader 30 wirelessly transfers power to mobile device 50. In particular, mobile device 50 is brought within sufficient proximity of access control reader 30 such that inductive coupler 34 is within inductive coupling distance of inductive coupler 54. For example, mobile device 50 may be brought within about 4 cm of access control reader 30. Power is then wirelessly transferred from internal power source 35 of access control reader 30 to battery 62 of mobile device 50, via inductive couplers 34 and 54. As known in the art, inductive coupler 34 generates an alternating electromagnetic field using energy from internal power source 35, and corresponding inductive coupler 54 detects the electromagnetic field and converts the electromagnetic field back into electrical current. For example, power may be transferred using the wireless Qi standard. However, other methods of transferring power (both current and future) are contemplated within the scope of this disclosure, such as methods that employ electromagnetic resonance.

At block 72, low-power island 57a is activated. For example, after mobile device 50 receives power from access control reader 30, a user may switch on mobile device 50. After being switched on, mobile device 50 detects the relatively very low state of charge of battery 62, and is therefore powered up in a low-power mode using low-power island 57a. In particular, low-power island 57a (as opposed to high-power island 57b) is activated as low-power island 57a operates at a lower voltage and/or lower clock frequency than high-power island 57b, and therefore draws less power from battery 62 than high-power island 57b would. The low-power mode may be a mode in which, for example, only basic functionality of mobile device 50 is activated, whereas activation of non-basic functionality is prevented or suppressed by low-power island 57a.

At block 73, access control application 58 is activated. Access control application 58 is used to generate access requests for transmittal via wireless communications transceiver 52. In the present embodiment, an access request comprises an access token, although in some embodiments an access request may comprise alternative or additional information that will be used for validation, such as a current location of mobile device 50.

For example, after low-power island 57a is activated, the user may provide a user input to mobile device 50 to instruct access control application 58 to initiate send an access request. For instance, after mobile device 50 has been switched on and low-power island 57a is activated, the user may be presented with an option to activate or open access control application 58. Access control application 58 requires only a relatively low amount of power in order to be activated, and therefore can be operated by low-power island 57a.

In some embodiments, instead of a user providing user input to activate access control application 58, access control application 58 is activated automatically in response to mobile device 50 being powered on by the user. Still further, in some embodiments, access control application 58 is activated automatically in response to sufficient power being transferred to battery 62, such that a user need not interact with mobile device 50 in order for access control application 58 to be activated (for example, mobile device 50 may automatically power on after receiving sufficient power from access control reader 30). In still other embodiments, mobile device 50 may be configured to transmit the access token without the need for access control application 58. For example, mobile device 50 may be configured such that, in response to detecting sufficient power has been transferred to battery 62, low-power island 57a immediately instructs wireless communications transceiver 52 to transmit the access token. The precise mode in which mobile device 50 operates to transmit the access token may be initially preset according to one or more factory settings; however, the mode may be configurable by the user, for example in response to the user inputting their credentials to mobile device 50 during setup/initialization of mobile device 50.

At block 74, in response to activation of access control application 58, access control application 58 causes wireless communications transceiver 52 to transmit the required access token. For example, in response to user input, access control application 58 reads the access token from token repository 60 and instructs wireless communications transceiver 52 to transmit the retrieved access token. The access token may be transmitted using a BLE communication channel. One advantage of using such a communication channel is that BLE communications are more widely supported on mobile devices, when compared to other forms of communication such as near-field communications.

At block 75, wireless communications transceiver 32 detects the access token transmitted from wireless communications transceiver 52. At block 76, access control reader 30 validates the access token. In some embodiments, in order to validate the received access token, processor 36 accesses a database of pre-validated access tokens stored in token repository 42, and compares the received access token to the pre-validated access tokens. The received access token is validated if the received access token corresponds (e.g. is identical to) one or more of the pre-validated access tokens. In other embodiments, access control reader 30 may send the received access token to a remote processor or processors for validation. The remote processor or processors may then validate the access token, and confirm with access control reader 30 (by communicating with processor 36) the validation of the access token.

In response to validating the access token, at block 77, processor 36 communicates with portal lock 38 to temporarily transition portal lock 38 from a locked state to an unlocked state. The user may then access portal 40.

The above-described embodiment of mobile device 50 relies on a processor 56 with multiple power islands 57a, 57b. One advantage of using power islands is that, given the relatively low power required for BLE transmissions, a user does not need to wait for an amount power to be delivered to mobile device 50 that would typically be required for the activation of all functionality of mobile device 50. In particular, low-power island 57a enables access control application 58 to be activated sooner than if the user powered on mobile device 50 in a normal power mode as opposed to a low-power mode.

However, in some embodiments, mobile device 50 may include a processor without any power islands, or a processor otherwise incapable of operating in a low-power mode. In such a case, the method described above may be implemented as follows: at block 71, access control reader 30 wirelessly transfers power to mobile device 50; at block 72, the processor of mobile device 50 is activated in a normal-power mode (for example in response to a user switching on mobile device 50); at block 73, access control application 58 is activated (for example in response to a user providing a user input to mobile device 50); at block 74, access control application 58 causes wireless communications transceiver 52 to transmit the required access token; at block 75, wireless communications transceiver 32 detects the access token transmitted from wireless communications transceiver 52; at block 76, access control reader 30 validates the access token; and at block 77, processor 36 communicates with portal lock 38 to temporarily transition portal lock 38 from a locked state to an unlocked state. Thus, the same access control method may be implemented, although in the absence of a processor with power islands, or in the absence of a processor otherwise incapable of operating in a low-power mode, it is likely that a user would have to wait a longer period of time before being able to transmit an access token to access control reader 30.

In yet other embodiments, instead of multiple power islands, mobile device 50 may comprise multiple, individual processors, for example a “secondary” processor configured to operate at a lower voltage and/or clock frequency than a “primary” processor. Thus, when sufficient power is transferred to mobile device 50, the secondary processor may be used to initiate transmission of the access token to access control reader 30

In further embodiments of the disclosure, mobile device 50 may comprise a capacitor connected to inductive coupler 54 and which is charged during wireless transfer of power from inductive coupler 34 to inductive coupler 54. Removing the coupling between inductive couplers 34 and 54 will cause the capacitor to discharge. The capacitor may be configured to provide power for launching access control application 58. Thus, during the discharge of the capacitor, energy from the capacitor powers access control application 58 which then (for example in response to user input) instructs wireless communications transceiver 52 to transmit the access request.

In some embodiments, transmittal of the access request may be triggered by access control reader 30. For example, access control reader 30 may include a transmitter for alerting mobile device 50 that they are within communication range of access control reader 30. Mobile device 50 may detect the signal at wireless communications transceiver 54 and, in response thereto, access control application 58 may transmit the access request to access control reader 30.

Mobile devices are typically designed to power down should the state of charge displayed on the device approach a low level such as 1% or 2% (this is set by the manufacturer and typically depends on the battery's chemistry). Such a feature is implemented to improve the longevity of the battery, since operating the battery at too low a state of charge reduces the battery's effectiveness over time. However, in some embodiments, it may be possible for the user to fully boot mobile device 50 despite a state of charge of mobile device 50 being at a level that would typically not permit a full boot of mobile device 50.

In particular, according to embodiments of the disclosure, a user may be provided with an option to allow mobile device 50 to fully boot despite the very low state of charge. For example, in response to a user switching on mobile device 50, the user may be presented with an option to fully boot mobile device 50 (typically, such an option is not presented, and instead the user would be advised via the device's display that the state of charge is too low to boot up the device). Alternatively, such an option may be automatically presented to the user (on the device's display) in response to mobile device 50 detecting the presence of access control reader 30. For example, such an option may be presented in response to mobile device 50 detecting power being received via inductive coupler 54, or by mobile device 50 detecting, via wireless transceiver 52, a transmission from access control reader 30. Note that despite having a low state of charge, battery 62 would in reality have sufficient power remaining to enable mobile device 50 to detect power being received via inductive coupler 54, or to detect a transmission from access control reader 30. Should the user select the option to proceed with the boot process, an override signal may be generated which would cause mobile device 50 to proceed with a full boot of mobile device 50, thereby providing sufficient time for the user to activate access control application 58 and initiate transmission of an access token to access control reader 30. In order to protect battery 62, mobile device 50 may be configured to automatically power down (either fully or into a low-power mode) following transmission of the access token, or else after a predetermined period of time has elapsed since the boot process.

As already noted, the above-described method may be used more generally for accessing any restricted resource. For example, instead of portal 40, access control reader 30 may be configured to control access to a computer resource, such as an encrypted or locked data file.

It is contemplated that any part of any aspect or embodiment discussed in this specification can be implemented or combined with any part of any other aspect or embodiment discussed in this specification.

While the above description provides examples of the embodiments, it will be appreciated that some features and/or functions of the described embodiments are susceptible to modification without departing from the principles of operation of the described embodiments. Accordingly, what has been described above has been intended to be illustrated non-limiting and it will be understood by persons skilled in the art that other variants and modifications may be made without departing from the scope of the disclosure as defined in the claims appended hereto.

1. A method comprising:
wirelessly transferring power from a power source to a mobile device, wherein the power source provides power to one or more components of an access control reader;
receiving at the access control reader an access request from the mobile device, wherein the access request is for accessing a resource;
authorizing, with access control reader, the access request; and
in response to authorizing the access control request, granting, with access control reader, access to the resource.

2. The method of claim 1, wherein the access request comprises an access token.

3. The method of claim 2, wherein authorizing the access request comprises validating the access token.

4. The method of claim 1, wherein, prior to wirelessly transferring power to the mobile device, a state of the charge of the mobile device is insufficient to allow the mobile device to transmit the access request to the access control reader.

5. The method of claim 1, wherein, prior to wirelessly transferring power to the mobile device, a state of charge of the mobile device is less insufficient to allow the mobile device to fully boot.

6. The method of claim 1, wherein wirelessly transferring power to the mobile device comprises wirelessly transferring power using inductive coupling between the access control reader and the mobile device.

7. The method of claim 1, wherein receiving the access request comprises receiving the access request over a Bluetooth® communication channel.

8. The method of claim 1, wherein, during the wireless transfer of power to the mobile device, the mobile device is less than about 4 cm from the access control reader.

9. The method of claim 1, wherein the resource comprises a physical portal or a data file.

10. A method comprising:
wirelessly receiving power at a mobile device from an a power source, wherein the power source provides power to one or more components of an access control reader;
transmitting an access request from the mobile device to the access control reader, wherein the access request is for accessing a resource; and
in response to access to the resource being granted by the access control reader, accessing the resource.

11. The method of claim 10, wherein the access request comprises an access token.

12. The method of claim 10, wherein transmitting the access request comprises using a secondary processor of the mobile device, wherein the secondary processor is configured to operate at one or more of a lower voltage and a lower frequency than a primary processor of the mobile device.

13. The method of claim 10, wherein transmitting the access request comprises using a first portion of a processor of the mobile device, wherein the first portion is configured to operate at one or more of a lower voltage and a lower frequency than a second portion of the processor.

14. The method of claim 13, wherein the first and second portions of the processor comprise respective power islands of the processor.

15. The method of claim 10, wherein transmitting the access request comprises:
activating an access control application on the mobile device; and
using the access control application to transmit the access request.

16. The method of claim 15, further comprising, prior to activating the access control application, determining with the mobile device that the received power is less than a threshold power.

17. The method of claim 16, wherein the threshold power is a power required for the mobile device to activate an operating system of the mobile device.

18. The method of claim 15, wherein activating the access control application comprises using a secondary processor of the mobile device, wherein the secondary processor is configured to operate at one or more of a lower voltage and a lower frequency than a primary processor of the mobile device.

19. The method of claim 15, wherein activating the access control application comprises using a first portion of a processor of the mobile device, wherein the first portion is configured to operate at one or more of a lower voltage and a lower frequency than a second portion of the processor.

20. The method of claim 19, wherein the first and second portions of the processor comprise respective power islands of the processor.

21. The method of claim 15, further comprising, prior to transmitting the access request:
detecting a user input at the mobile device; and
in response thereto, activating the access control application.

22. The method of claim 10, wherein, prior to wirelessly receiving power at the mobile device, a state of the charge of the mobile device is insufficient to allow the mobile device to transmit the access request.

23. The method of claim 22, wherein, prior to wirelessly receiving power at the mobile device, a state of charge of the mobile device is insufficient to allow the mobile device to fully boot.

24. The method of claim 10, wherein wirelessly receiving power at the mobile device comprises wirelessly receiving power using inductive coupling between the access control reader and the mobile device.

25. The method of claim 10, wherein transmitting the access request comprises transmitting the access request over a Bluetooth® communication channel.

26. The method of claim 10, wherein, during the wireless receipt of power from the access control reader, the mobile device is less than about 4 cm from the access control reader.

27. The method of claim 10, wherein the resource comprises a physical portal or a data file.

28. The method of claim 10, further comprising, in response to detecting the wireless receipt of power at the mobile device, or in response to detecting a wireless transmission received at the mobile device from the access control reader, generating an override signal that initiates a boot sequence on the mobile device, wherein the override signal overrides a previous signal that prevented initiation of the boot sequence.

29. An access control reader comprising:
a wireless power transmitter;
a power source for providing power to the wireless power transmitter; and
one or more processors communicative with a memory having stored thereon computer program code configured when read by one or more processors to cause the one or more processors to perform a method comprising:
authorizing an access request received from a mobile device, wherein the access request is for accessing a resource; and
granting access to the resource.

30. A mobile device comprising:
a transmitter;
a processor having a first portion and a second portion, wherein the first portion is configured to operate at one or more of a lower voltage and a lower frequency than the second portion; and
memory communicative with the first portion and having stored thereon computer program code configured when executed by the first portion to cause the first portion to perform a method comprising:
transmitting with the transmitter an access request for accessing a resource.

31. A system comprising:
a resource;
a mobile device; and
an access control reader; and
a power source for providing power to the access control reader, wherein the access control reader is configured to:
wirelessly transfer power to the mobile device;
thereafter, authorize an access request received from the mobile device; and
in response to authorizing the access request, grant access to the resource.
